(19) United States
(12) Patent Application Publication
(10) Pub. No.: US 2006/0053048 A1
(43) Pub. Date: Mar. 9, 2006

(54) Techniques for remotely delivering shaped display presentations such as advertisements to computing platforms over information communications networks

(75) Inventor: Igor Tandetnik, Forest Hills, NY (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: WhenU.com, New York, NY (US)

(21) Appl. No.: 10/934,734

(22) Filed: Sep. 7, 2004

Related U.S. Application Data
(60) Provisional application No. 60/606,902, filed on Sep. 3, 2004.

(51) Int. Cl. G06Q 30/00

(52) U.S. Cl. 705/14

(57) ABSTRACT

A high impact desktop or palmtop product placement or “shaper” display presentation technique overcomes disadvantages of previous ad display techniques while providing high consumer interest and increased flexibility for content creators. An advertisement is run in front of or behind a web browser view so it appears with the user's desktop as background, and in a non-rectangular shape that looks nothing like a traditional pop-up or pop-under ad. A “shaper” ad can, for example, have any desired shape such as for example an exact replica of a product being advertised e.g., a cell phone, a Sports Utility Vehicle climbing a mountain, a plasma television set, etc.

### CROSS-REFERENCES TO RELATED APPLICATIONS

This application claims the benefit of Provisional Application No. ______, filed Sep. 3, 2004 entitled “Techniques For Remotely Delivering Shaped Display Presentations Such As Advertisements To Computing Platforms Over Information Communications Networks” (attorney docket no. 4581-3), the entire content of which is hereby incorporated by reference.

### FIELD

The technology herein relates to remotely controlling the display of information, and more particularly to delivering advertising and other presentations over a digital communications network for display on a consumer's networked appliance. Still more particularly, the technology herein relates to delivering shape information with a creative to provide flexible shaping of displayed advertisements that can be launched on a consumer's desktop or palmtop.

### BACKGROUND AND SUMMARY

To be effective, a message must be noticed and acted upon. Advertisers and other communicators have devoted a great deal of effort to developing ways to deliver messages to people likely to be receptive those messages, at times when those people are likely to be receptive and can act on the messages, using delivery mechanisms that will attract attention—all to increase the likelihood that the people receiving the messages will notice, pay attention to and act favorably.

One example commonplace but effective advertising technique we are all familiar with is the use of highway billboard signs to advertise products and services (e.g., food, fuel, hotels, etc.) motorists are likely to need while on the road. Such billboards can be placed and sized so they are difficult for motorists to miss. The billboards deliver their messages to potential consumers at a time when those consumers are likely to need the products or services being advertised and can stop to take advantage of the goods and services being offered.

Rather than physically traveling to destinations, consumers are now increasingly using the so-called “Information Superhighway”—the collection of information communications networks including the Internet, cellular telephone networks, wireless wide area networks, etc.—to conduct more and more of their purchasing transactions and purchasing research online. Many consumers now use networked personal computers, personal digital assistants or cellular telephones with web-browsing capabilities to research products and services they are interested in purchasing. For example, potential car buyers often use the Internet to research and compare the features, prices and safety records of different makes and models of new and used cars. Many consumers purchase books, home electronics, toys and many other products over the Internet. Internet-based auctions have created new, efficient markets for products of every imaginable description. Consumers are also increasingly using the Internet and other networks to research financial-related products and services such as insurance, personal and home loans, and investments. These trends will continue and become more pronounced as convenient, easy-to-use graphical interface based networking capabilities are extended to pocket PCs, cellular telephones, personal digital assistants and a range of other networked appliances. Many have therefore attempted, with varying degrees of success, to punctuate the information superhighway user experience with the electronic equivalent of billboards, by delivering information to consumers electronically in a way that the consumers will notice and pay attention to the information, and in a timely manner so the consumers can use the information effectively.

The average Web surfer has much more information at her fingertips than a typical television viewer. Unlike TV viewers, Web surfers don't simply meander around just to see what's available, with little control over the direction of the content. Consumers use the Web with distinct intent, whether it's conducting research, shopping, or consuming news content. In general, however, Internet advertising in the past has taken the television mass-market approach, without taking into account the generally self-directed, interactive nature of the online experience. Many current methods in online advertising haven't been able to deliver on the promise of the Internet as a rich, personalized consumer contact point. Poorly targeted emails, pop-ups and banner ads have yielded annoyed consumers, “click-through” rates of less than one percent, and millions of wasted ad dollars. To leverage the full potential of the Internet as a consumer sales channel, advertisers must make their offers as relevant and timely as possible, attracting the consumer's attention at the precise moment that they demonstrate an interest in that type of product.

A variety of techniques have been used in the past to attract consumer attention to advertisements delivered over digital communications networks such as the Internet. For example, some such techniques display advertisements as part of a displayed web page or other content in the general style of a print newspaper (e.g., sidebars, banners, etc.). Recently, so-called “dynamic html” programming has made possible more interesting animated “hover” or “floating” ads that appear on and may move across a displayed web browser view. Such “floating” ads can have any shape, but are generally constrained to be displayed in the foreground within the confines of a browser view. Oftentimes, therefore, floating ads tend to obscure underlying content unless the content has been laid out specific to accommodate the floating ad.

Another technique called “pop-up” ads display a new display window in the foreground, i.e., in front of any other content that may be displayed. Techniques such as floating and pop-up ads can be effective in providing conspicuous, highly-noticeable display of advertising and other messages that consumers are likely to pay attention to. Think for example of turning to an article in a newspaper or magazine and being unable to read the article until you remove an advertising overlay. While such techniques are entirely suitable for some types of advertising and other messages (e.g., weather or emergency alerts) and are very effective in reaching consumers (e.g., especially those who value contextual advertising and enjoy watching interesting visual effects), some consumers and advertisers do not wish to have retrieved content obscured or interrupted, even temporarily, by advertising displayed in an overlayed fashion over top the content the consumer intends to retrieve.

One technique previously developed to address these concerns is the so-called “pop-under” ad. “Pop-under” ads are similar to pop-up ads except they appear behind some or all of the browser windows that the consumer is viewing. Pop-under ads have the advantage of not obscuring content within the “front” browser window displaying the content the consumer intended to retrieve. However, because of limitations in current web browsers and associated standards and protocols, such pop-under ads are generally limited to the rectangular format of a typical browser window. Another so-called “panoramic” window approach generally appears along an edge of the display (e.g., horizontally along the bottom of the display)—once again in a generally rectangular format that does not obscure the content the user intended to retrieve.

A previous attempted implementation of “transparent pop-ups” provided some advantageous features. However, this particular implementation could be computation-intensive—particularly when a pop-up was to be moved or resized. This sometimes made dragging such a popup noticeably slow even on a high capability computation device. Furthermore, this particular exemplary past implementation did not provide true transparency in the sense that a mouse click on an apparently transparent pixel did not actually go through to the underlying window. To avoid potential user confusion, advertisers sometimes tried to avoid leaving such a transparent pop-up open for a long time, or to move it around so that it played out its transparent animation or movie and then collapsed to some fully opaque rectangular static picture. Thus, while certain advantages were provided, further improvements were possible and desirable.

The various existing message presentation techniques each have their respective advantages and disadvantages. There is an opportunity for additional creativity and innovation to deliver effective message presentation to consumers via networked appliances. For example, there remains a need to provide more creative, flexible display of remotely served advertising and other content in other than conventional rectangular shapes but in ways that do not necessarily obscure other content retrieved over a digital communications or other network. For example, it would be interesting and advantageous to assign a truly non-rectangular shape to a remotely served pop-up or other display presentation.

We have developed a new, high impact content display presentation technique that overcomes disadvantages of previous ad display techniques while providing high consumer interest and increased flexibility for content creators.

In one example illustrative non-limiting implementation we refer to as desktop product placement or “shaper” technology, we run an advertisement behind a web browser view so it appears with the user's desktop as background, and in a non-rectangular shape that looks nothing like a traditional pop-up or pop-under ad. In our illustrative non-limiting exemplary implementation, a “shaper” ad can, for example, have any desired shape such as for example an exact replica of a product being advertised (e.g., a cell phone, a Sports Utility Vehicle climbing a mountain, a plasma television set, etc.).

The exemplary illustrative non-limiting implementation of the technology is completely flexible and can show an advertising or other message in any shape and any form without the need for the advertiser to do anything more complex than to create an appropriately formatted creative and cut it out in the shape they want. Unlike traditional floater ads, presentations provided by the exemplary illustrative non-limiting implementation appear as part of the display background rather than as part of a web page and therefore do not obscure a current browser view or require a new browser window unless specifically designed to do so. Such shaper technology may, in one illustrative non-limiting example, launch directly to the consumers desktop, where it remains for the consumer to encounter once all browser windows are closed.

In one exemplary illustrative non-limiting implementation, a “shaping” advertisement or other content presentation technique provides the ability for an HTML creative to define a shape different from a basic rectangle. For example, when using frames in a web page, each frame or inline frame no matter how deeply nested, can define its own shape. The overall shape of the presentation is determined by combining the shapes of all frames and inline frames.

To support presentations of various sizes in one exemplary illustrative non-limiting implementation, a shape can consist of a number of pieces defining the shape of different parts of the presentation. For example, separate pieces can define the shapes of each of four corners and each of four middle sections of each side. Additional pieces may define repeatable fillers (e.g., two on each side on either side of the middle section, and a further piece can define the shape of the center of the presentation. The pieces may define shape characteristics for example using a monochrome (black and white) image or overlay mask, where for example a black pixel defines opaque (non-transparent) and a white pixel defines transparent. The size of the image or mask may determine the size of the corresponding piece. Any convenient type of representation or format can be used to define the shapes (e.g., monochrome GIFs, JPEGs, bitmaps, etc.) Any piece can be omitted—meaning that the basic rectangular shape should stay in place unaltered in a place this piece would otherwise occupy (e.g., the creative may use a default shape such as rectangular at that point).

In one exemplary illustrative non-limiting implementation, the shape-defining pieces may load over a network from a remote location such as a server. A flag or other indicator may be used to designate different shape-defining pieces as critical or non-critical. Pieces indicated as being critical are treated as necessary for displaying the presentation—if the piece is not present (e.g., it fails to download), then the presentation should be abandoned and not shown to the consumer. Display of the presentation can proceed using defaults if non-critical (e.g., merely decorative) shape-defining pieces fail to load.

In one exemplary illustrative non-limiting implementation, a presentation can dynamically change its shape during display under various conditions. For example, when resized, all the pieces of all the frames of the presentation may be recombined to reflect the new sizes. Also, when any frame navigates to a new page, the overall shape of the presentation may be reconstructed, taking into account the removal of the shape in the unloaded page and any shape possibly defined by the newly loaded page. In addition, operations may be used to clip or otherwise attach the shaped presentation to a given rectangular or other additional presentation while preserving the shape of the shaped presentation.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1A-1H show non-limiting illustrative implementations of example shaped advertising presentation displays;

FIGS. 2A and 2B show an example illustrative non-limiting creative and corresponding overlay, respectively;

FIG. 3 shows an example illustrative non-limiting content delivery and display system;

FIGS. 4A and 4B are together a flowchart of example illustrative non-limiting program control steps;

FIG. 5 shows an example illustrative non-limiting schematic illustration of how the FIG. 2B overlay may be mosaically defined; and

FIG. 6 shows an example storage medium storing an example illustrative non-limiting data structure defining a shaped presentation.

### DETAILED DESCRIPTION

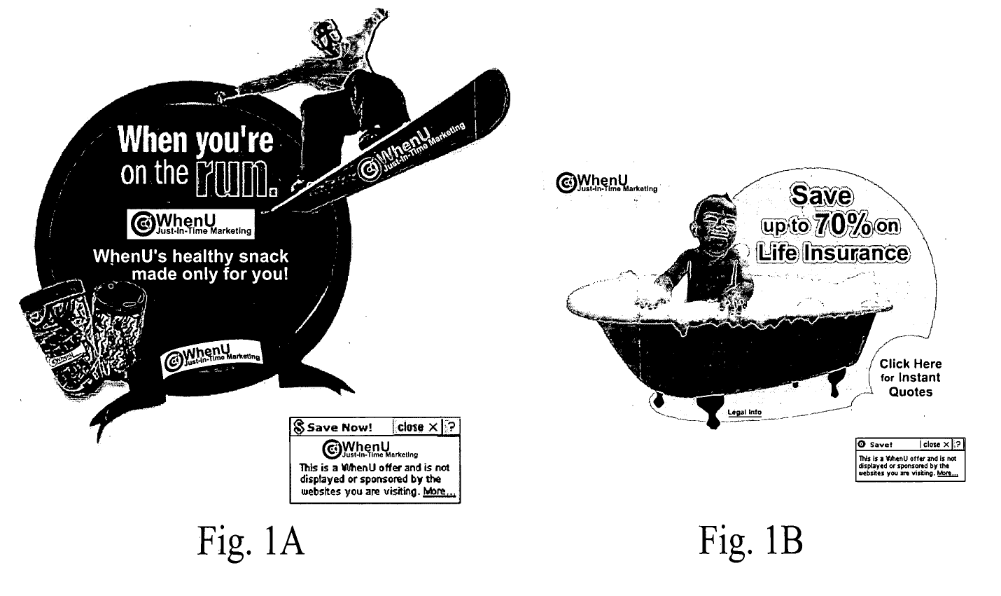

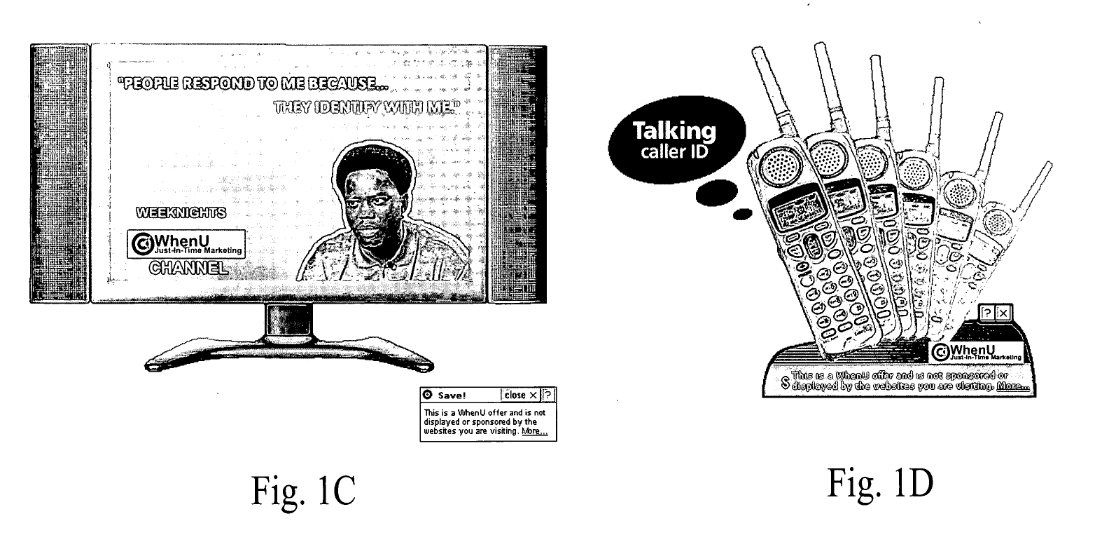

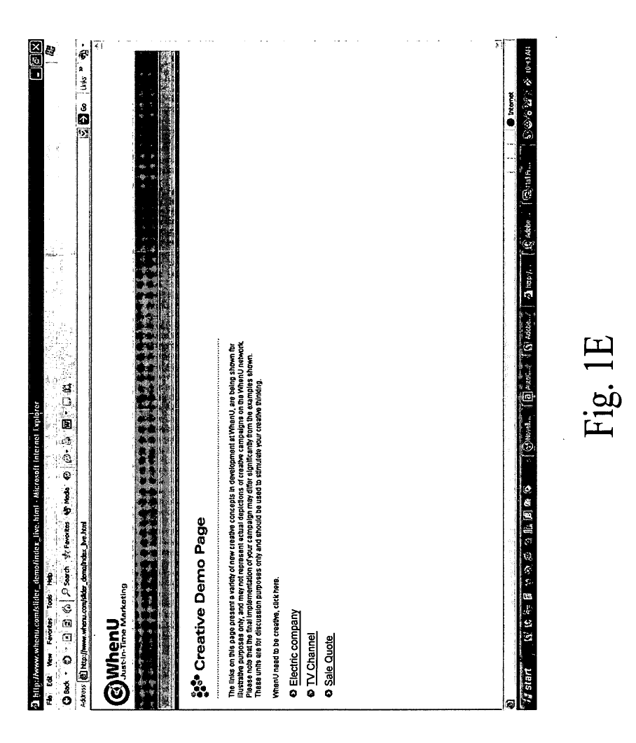

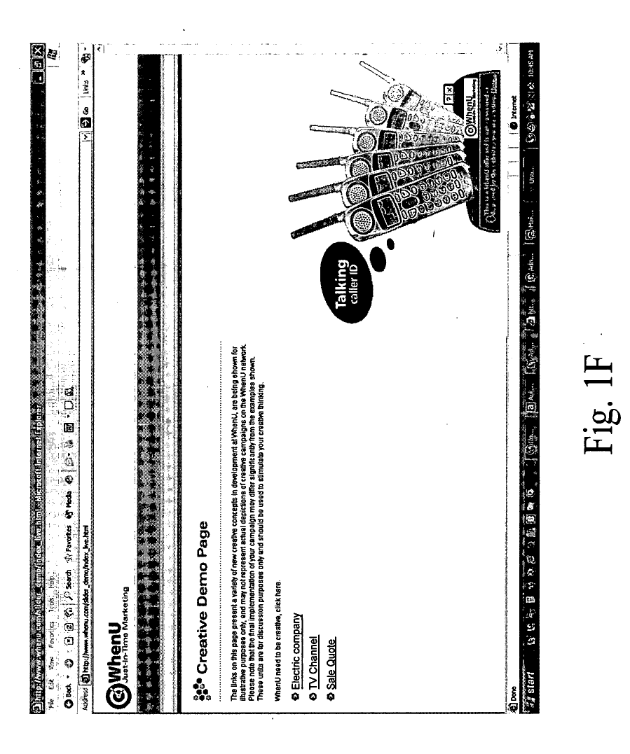

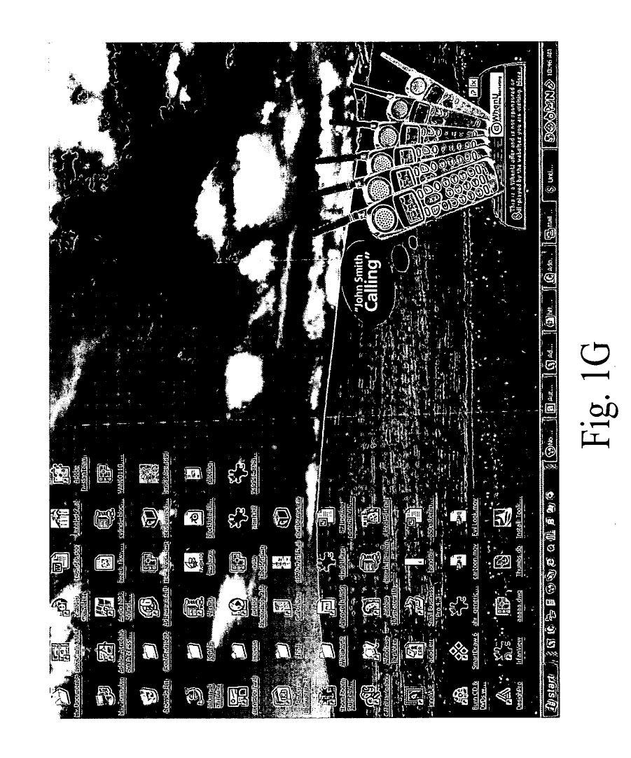

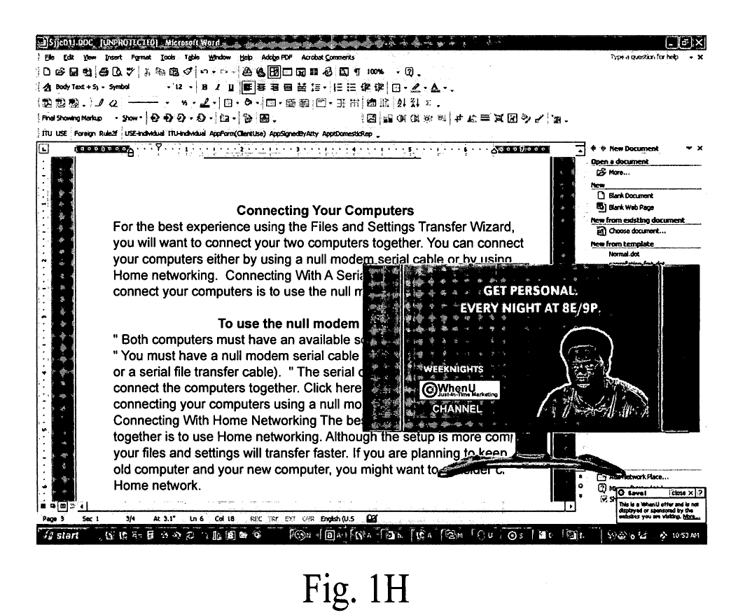

FIGS. 1A-1D show illustrative non-limiting examples of actual displays of shaped advertising presentations 100 provided by the technology described herein. These Figures show presentations 100 that are launched as background to a consumer's desktop or palmtop, so that they do not obscure content displayed in open browser windows but are readily visible when the consumer closes or minimized the browser windows. As shown in these Figures, presentations 100 can have almost any conceivable shape—e.g., a cellular telephone, a sports utility vehicle, a bowl of soup, a person's face, or any shape a content creator desires. In the example illustrative non-limiting implementations shown, the shapes are not limited to rectangular outlines, nor are they limited to being displayed within a browser window.

In the example non-limiting implementations shown, consumer-initiated mouse clicks or other user-initiated interactions over the opaque or otherwise visible portions of the presentations cause the presentation (in conjunction with associated software-defined functionality) to initiate responsive action such as, for example:
opening a browser view of a predetermined web page,
presenting more information about a product or service being offered for sale (e.g., playing a streaming video and/or audio clip, “Flash” presentation, etc.),
presenting information about the content delivery service,
closing or minimizing the displayed presentation,
animating or otherwise dynamically changing, moving or resizing the presentation, and/or
other action.

As can be seen in FIGS. 1A-1D, the presentation 100 can include any sort of graphics and/or any desired text. The graphical presentation can be contiguous or non-contiguous (e.g., there may be voids such as holes in a doughnut that are transparent to show background information through and that the user's mouse clicks can penetrate to select underlying items displayed on the background). For example, the exemplary non-limiting FIG. 1B example shows a large center section (baby in bathtub) with additional non-contiguous “floating” sections (e.g., trademark or brand name bubble, rectangular window with controls, etc.) The presentation 100 can be static or it may move across the screen, and may be animated or non-animated (e.g., the “bubbles” shown in FIG. 1B can move or animate, and the words can with time to provide a changing, attention-grabbing message). In the exemplary illustrative non-limiting implementations, presentations 100 may appear to the user as part of the desktop or palmtop, although they may be sized much larger than a conventional desktop icon so as to be quite conspicuous and noticeable. The presentation may initially appear as part of a browser view (see FIG. 1E, 1F) but may be independent of it in the sense that when that particular browser view is closed, the presentation may remain as part of an underlying application (see FIG. 1H) or ultimately as part of an underlying desktop or palmtop display (see FIG. 1G). If displayed in front of a browser window or the window of some other application, the presentation 100 may move “behind” that other window by simply clicking a mouse onto the window to display that other window “in front of” the presentation. In such case, the presentation 100 ends up being displayed as part of the underlying desktop (see FIG. 1G) so that it is available to be noticed by the consumer when all other windows are closed, minimized, etc.

When the user clicks anywhere on the non-transparent portions of a presentation 100, one exemplary illustrative non-limiting implementation will initiate a http request for a web page at an associated advertiser's web site, to cause and open display of a browser web page view or other supplemental presentation (e.g., the advertisers home or other web page in one exemplary illustrative non-limiting implementation). In some exemplary illustrative implementations, the user may single click and “drag” (hold mouse button down) on certain portions of a presentation 100 to drag or otherwise move the presentation on the screen and/or to resize the presentation. A presentation 100 may also include control buttons-either as part of the shaped area (see e.g., FIG. 1D) or in a supplemental rectangular or other window portion (see e.g., FIG. 1A-1C). Clicking on the “x” button may close the presentation, while clicking on the “?” button or the “more” link may open a window to provide more information about the advertising service. Because of the flexibilities provided, the creativity of the presentation designer is the only limit to the range of expression available.

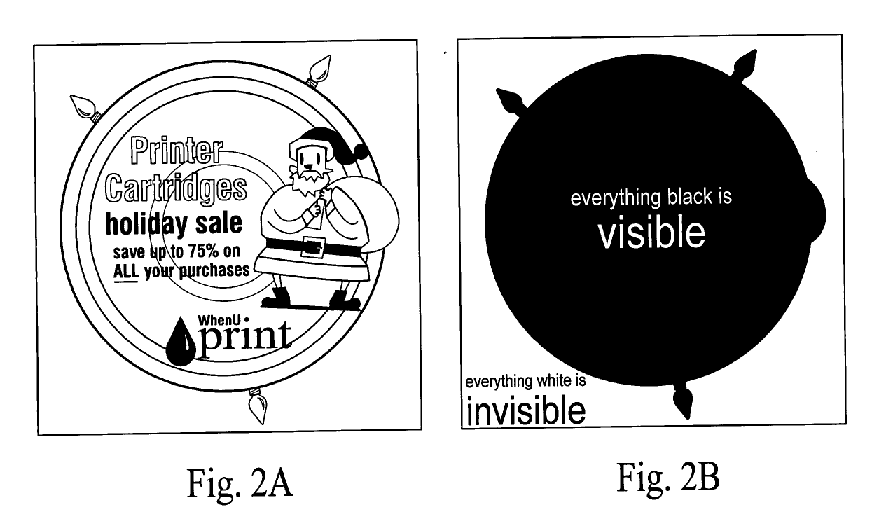

FIGS. 2A & 2B illustrate the basic technique used by the exemplary non-limiting implementation to provide the shaped displays described above. In this exemplary non-limiting implementation, the presentations are made up of two different images that are combined to provide an end result:
the actual “creative” or content that is to be delivered to the consumer (see FIG. 2A); and
an overlay image (see FIG. 2B).

The FIG. 2A “creative” image can be for example a conventional rectangular image represented in any desired format such as for example a gif, animated gif, jpg, Flash graphical image or rich media format. The FIG. 2A image definition may include html with input fields/dropdowns, for example using the GET http method. Sound may be included if desired. If the FIG. 2A creative is be represented by a Flash SWF and/or html code that combines several images or flash pieces, then in the exemplary illustrative implementation an accompanying static backup image is also provided that represents the entire creative. In one particular non-limiting implementation, the edges of the creative are aliased in a conventional fashion to avoid color banding. A branding line style (e.g., thick or thin) may also be specified along with a company logo if desired, to be used for displaying a branding line module in response to the user selecting a “?” button or a “More” link.

In the exemplary illustrative non-limiting implementation shown, the FIG. 2B overlay image comprises a rectangular black and white image represented for example in the gif format. In the particular example shown, everything defined as black in the overlay image will be visible in the displayed presentation, and everything that is white will not be visible. In the illustrative implementation shown, objects do not move outside of the original overlay image. Given this rectangular bitmask (e.g. a monochrome image), it is possible to construct a region and assign it to a display presentation such as a popup so that every 0 (black) bit corresponds to a non-transparent pixel and every 1 (white) bit corresponds to a transparent pixel. “Transparent” here means truly transparent—windows behind the popup show through and can accept mouse clicks.

The FIG. 2B image may be created by drawing shape pieces in any graphical editor such as PhotoShop, upload them to the server, then manually put appropriate <meta> tags referring to these pieces into the HTML creative of FIG. 2A. No automated tools need to be used, it can all be done by hand.

### Example Illustrative Non-Limiting Presentation Delivery System 100

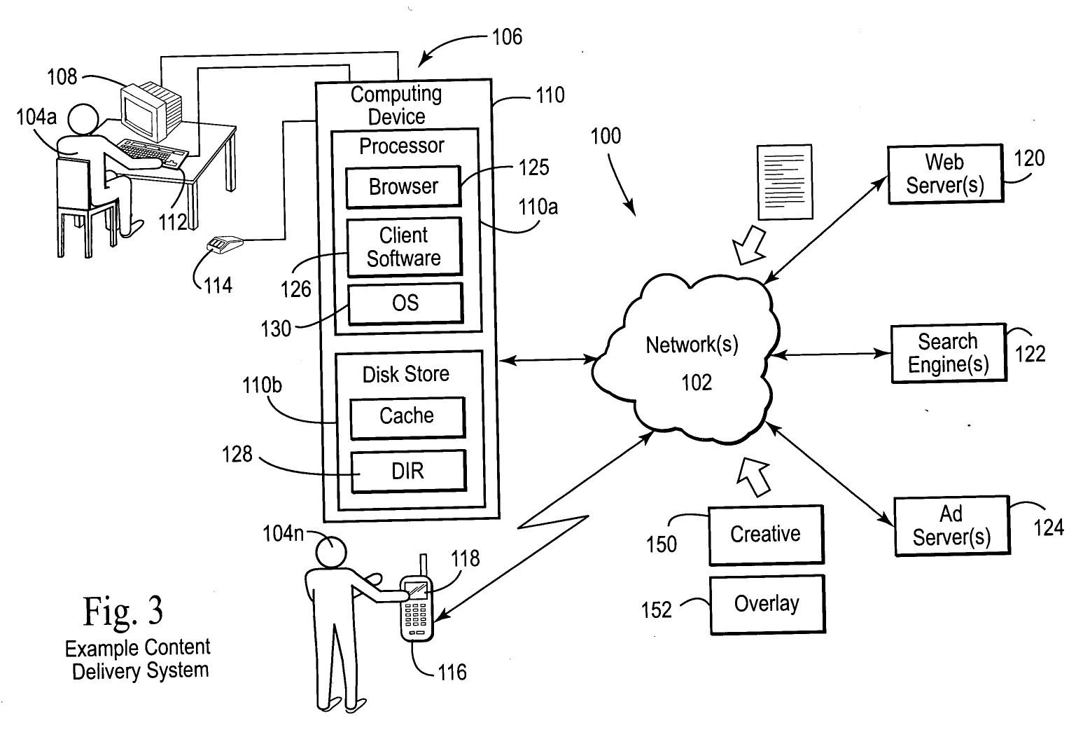

FIG. 3 is a schematic diagram of an illustrative non-limiting exemplary content and presentation delivery system 100 that may be used to deliver shaped advertisements and other content to consumers. In the example shown, system 100 uses a network 102 to deliver presentations to consumers 104. While only two consumers 104A, 104N are shown in FIG. 3, the system 100 is scaleable such that it can deliver information to any number of consumers.

In the Figure, consumer 104A is using a personal computer 106 including a display 108, a computing device 110 including a processor 110a and storage 110b, and various input/output devices such as a keyboard 112 and a mouse pointing device 114. Another consumer 104n uses a different type of computing appliance 116 such as for example a cellular telephone, pocket PC, personal digital assistant with wireless adapter, or any other type of networked appliance with a display 118. Virtually any type of networked or connected appliance with a display may be used.

Personal computer 106 and bandheld device 116 are each connected via network 102—which may comprise any type of network such as for example the Internet, a wide area network, a local area network, a wireless or wired network, a cellular or other telephone network, a public data network, or other digital communications medium. Personal computer 106 and handheld device 116 are able to communicate over this network 102 with a variety of web servers 120, search engines 122 and ad servers 124.

Software installed on personal computer 106 and handheld device 116 provides a global Desktop Advertising Network (“DAN”) that applies sophisticated precision logic at the desktop level. From the desktop, client software downloaded onto the user's networked appliance 106, 116 with the user's permission and knowledge, examines keywords, URLs and search terms currently in use on the consumer's browser—without collecting or transmitting this data—and then selects relevant and useful advertisements. For example, if a consumer uses the Web to find vacation packages to New York, a particular travel service's discounted New York travel packages can be immediately displayed to the user. This level of relevance benefits advertising partners and consumer audiences alike, as consumers receive offers that save millions of dollars annually, while advertisers can reach predisposed target audiences at key moments in their research or buying process. This contextual marketing technology makes it possible to market products and services to consumers who have a demonstrable interest in those products or services, at the moment the consumer demonstrates an interest in the product or service, without requiring any knowledge of the consumer's past history or personal characteristics. Such targeting technology has been sold by WhenU.com for several years now and has been highly successful in its own right. For more information, see the whenu.com website and Save and SaveNow software, which is incorporated herein by reference.

In more detail, participating consumers 104 receive contextually relevant advertisements, delivered to their networked appliance display screens 108, 118 (e.g., “desktops”, “palmtops”, etc.). These advertisements are selected based on an analysis of the consumer's immediate interests, as reflected by the consumer's browsing activity. Consumers typically download software 126 providing these advertisements in return for obtaining a free software application (e.g., clock synchronization software, weather forecasting software, ring tones, etc.) and/or based on receiving discounts, credits or other offers. Under current technology, the presence of client software 126 running on the user's appliance gives the patentee's Desktop Advertising Network some distinct advantages in terms of flexibility, functionality and capabilities that are not available in other technology models based solely on web pages or frames downloaded to a web browser. One advantage is the ability to launch applications on the appliance desktop or palmtop, outside of any browser view or context.

Advertisements shown by patentee's client software 126 are delivered remotely from a server 124 based on a mapping operation performed using an ad set-up table. Each advertisement is assigned a name and a variety of parameters such as size, priority and frequency. The patentee maps the ad by determining the various categories (e.g., “Air Travel”) and keyword algorithms that will trigger the appearance of the advertisement, subject to priority and frequency limitations. The resulting mapping data is recorded into a directory 128 that is delivered to and saved on the consumer's appliance. This directory is optimized and updated periodically (e.g., daily) through interactions with a server 120, 124.

As a participating consumer 104 browses the Internet, the client software 126 studies the user's browsing activity and analyzes it relative to the directory 128. The client software 126 looks at both user inputs (e.g., words the user inputs into an browser input field) and at the content retrieved based on the user's interaction with the browser. This analysis determines whether the browsing activity is associated with a category in the directory, and whether relevant categories are associated with particular advertisements. If the software finds a match, it identifies the associated product or service category, determines whether appropriate ads are available to be displayed, and if so, selects an ad (ad selection may also be based on other, external factors such as frequency and/or priority as is well known). The client software 126 also may determine that the consumer 104 is interested in a particular category of products or services if it finds certain combinations of words in the content of visited web pages or other content. For example, if a participating consumer accesses a webpage containing several occurrences of “home mortgage”, the client software may determine that the consumer is interested in the “finance.mortgage” category and may select an ad that is associated with that category.

As further shown in FIG. 3, ad server 124 may deliver shaper advertisements as described above to client software 126 for display. In the example shown, ad server 124 may deliver both creatives 150 and corresponding overlays 152. Client software 126 in the exemplary illustrative non-limiting implementation combines these two entities 150, 152 and displays a resulting visual presentation using the “Region” functionality provided as part of the Graphical Device Interface (GDI) of conventional Microsoft Windows 95, Windows 2000 and Windows XP operating systems 130. Client software 126 launches the resulting shaped presentation onto the desktop or palmtop of the consumer's appliance 106, 116 for display, as shown in FIGS. 1A-1D.

Exemplary Illustrative Non-Limiting Display Presentation Method

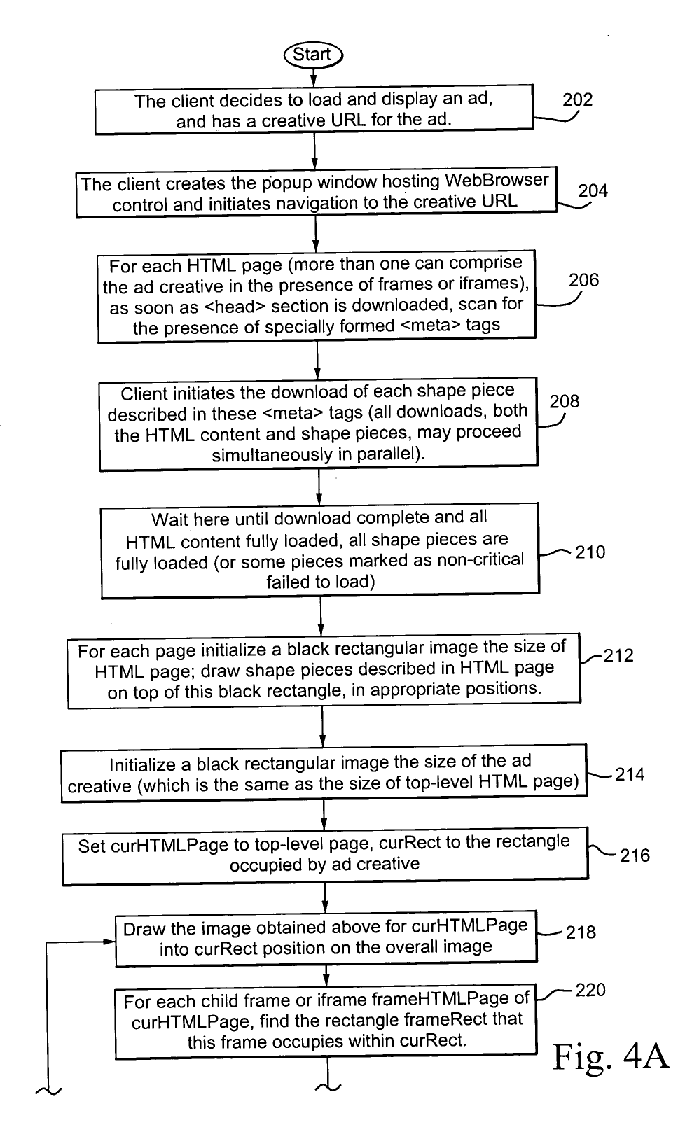

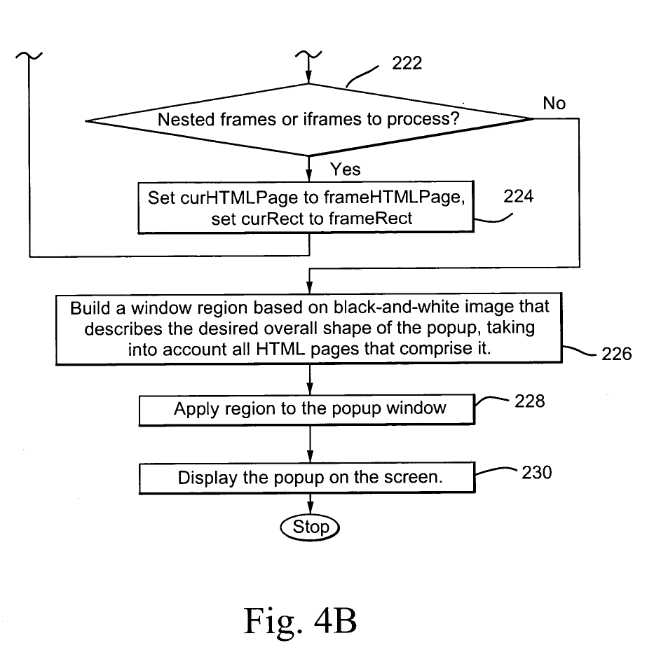

FIGS. 4a and 4b together are a flowchart of an example illustrative non-limiting implementation of an advertisement presentation technique for delivering shaped advertisements over network 102. At the start of the process, the client software 126 decides to load and display an ad, and has a creative URL for the ad (FIG. 4a, block 202) The client 126 creates the popup window hosting WebBrowser control, and initiates navigation to the creative URL (block 204). For each HTML page (more than one can comprise the ad creative in the presence of frames or iframes), as soon as <head> section is downloaded, it is scanned for the presence of specially formed <meta> tags indicating a shaper ad (block 206).

. In one exemplary illustrative non-limiting implementation, to define a shape, a creative should contain, in its <head> section, one or more META tags of the following form:

<meta name=“whenushape” content=“PieceID,Flags,URL”>

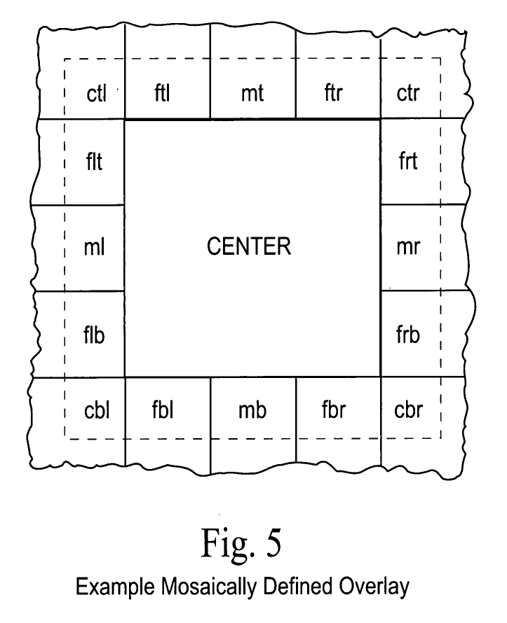

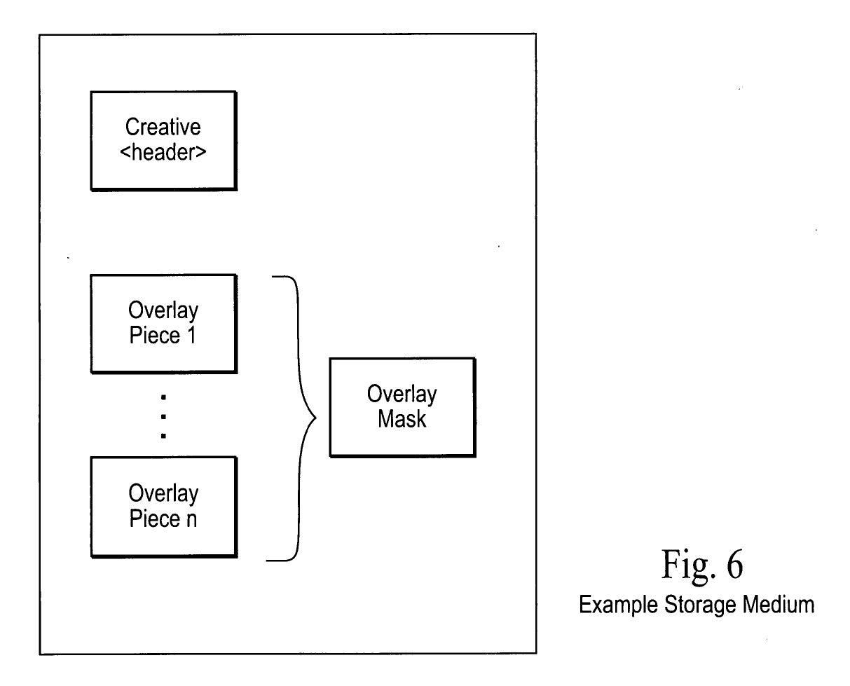

Such meta tags specify an associated set of overlay information 152 used to define the shape of the presentation. To support display presentations of varying size, the overlay shown in FIG. 2B may be converted before use into a bit mask and divided into a number of different pieces. An example illustrative non-limiting “mosaic” type implementation shown in FIG. 5 is divided into up to seventeen (17) pieces: four corners, four pieces in the middle of each side; eight repeatable fillers (two on each side of the presentation on either side of the middle piece), and the center. Each piece is defined by a monochrome (black and white) image, where a black pixel becomes non-transparent and a white pixel becomes transparent. The size of the image determines the size of the corresponding piece. Any piece can be omitted, which means that the basic rectangular shape should stay unaltered in a place which this piece usually occupies. In particular, if no piece is specified then the creative retains its rectangular shape.

Thus, in this particular example, “PieceID” may be one of for example:
center—center piece
ctl or clt—top left corner
ctr or crt—top right corner
cbl or clb—bottom left corner
cbr or crb—bottom right corner
ml—middle piece along left side
mt—middle piece along top side
nr—middle piece along right side
mb—middle piece along bottom side
ftl—filler along top side to left of the middle
ftr—filler along top side to the right of the middle
fbr—filler along bottom side to right of middle
fbl—filler along bottom side to left of middle
fit—filler along left side to top of middle
fib—filler along left side to bottom of middle
frt—filler along right side to top of middle
frb—filler along right side to bottom of middle.

Any convenient desired naming convention could be used. Furthermore, different partitions or numbers of partitions could be used. For example, an alternative exemplary non-limiting implementation uses up to 8 (eight) shape elements for a particular popup (four corners and four sides). This can be done by providing 8 individual images (from 8 individual URLs), or by providing one image that contains them all along with the information of how to cut 8 elements out of it (e.g. 8 sets of left-top-width-height coordinates, one for each piece). The multiple image approach is attractive in that graphics designers don't have to do math when authoring shapes. All the information needed to compose the final bitmask can be obtained just from the sizes of various pieces. With the multiple image approach, there is a possibility to accidentally mismatch images (configure a shape from images that were not actually designed to work together), but this may be less likely. As will be understood, this exemplary arrangement allows display of virtually any arbitrary shape—which could of course include rectangular, square, rhomboid, circular or other regular geometrical or non-geometrical shape(s) as desired.

In one exemplary arrangement, the presentation is not shown until all pieces composing the shape arrive. Thus, a missed delivery could potentially cause the entire presentation to be abandoned or delayed. However, pieces that are shown often (like rounded corners that go with a default skin and get applied to every popup) are very likely to be in the browser cache.

To further increase performance under some circumstances, the exemplary illustrative non-limiting implementation provides a flag for each piece definition, the flag indicating if the piece is “critical” (i.e., the presentation will not display without it being present). In the exemplary illustrative implementation, if the “Flags” field is empty or “0”, this shape piece is not critical, meaning the presentation can be shown even if it fails to download for any reason. If the “Flags” field is “1”, this piece is critical, meaning that the presentation should be abandoned and not shown to the user if this piece fails to download (say, a piece that defines an overall shape for the presentation, rather than being merely decorative).

In the example non-limiting illustrative implementation, the “URL” field provides a URL (universal resource locator) pointing to the image defining this piece of the overlay. This can be an absolute URL, for example, or it may be relative to the URL of the creative itself.

The following are example META tags defining a complete shape:
<meta name=“whenushape” content=“ctl,,shapes/top_left_corner.gif”>
<meta name=“whenushape”
content=“center,1,http://whenu.com/shape/donut.gif”>

Referring again to FIG. 4a, the client 126 initiates the download of each shape piece described in these <meta> tags. All downloads, both the HTML content and shape pieces, proceed simultaneously in parallel (block 208). The download is complete when all HTML content is fully loaded, and all shape pieces are fully loaded (or some pieces marked as non-critical failed to load) (block 210).

At this point, the client assembles an overall shape of the popup. Remember that each shape piece is a black-and-white rectangular image, and the specification of the shape in the <meta> tag indicates which part of the overall shape of the HTML page it describes—a corner, a center piece, a repeated filler along one side and so on).

For each HTML page comprising the creative (top-level page, frame or iframe), the following operations are performed:
Initialize a black rectangular image the size of this HTML page (block 214); and
Draw shape pieces described in this HTML page on top of this black rectangle, in appropriate positions (block 212).
The result is a rectangular black-and-white image describing the desired shape of this particular HTML page.

Now we need to assemble the overall shape of the popup. Note that frames and iframes can be nested arbitrarily deep—a top-level page may contain frames, which in turn may contain more frames, and so on. In other words, frames and iframes form a tree with the top-level HTML page as its root. The algorithm traverses this tree as follows:
Initialize a black rectangular image the size of the ad creative (which is the same as the size of top-level HTML page) (block 214).
Set curHTMLPage to top-level page, curRect to the rectangle occupied by ad creative (block 216)
Draw the image obtained at step 5.3 for curHTMLPage into curRect position on the overall image. (block 218)
For each child frame or iframe frameHTMLPage of curHTMLPage, find the rectangle frameRect that this frame occupies within curRect (block 220). Repeat block 218 recursively with curHTMLPage set to frameHTMLPage, and curRect set to frameRect (see blocks 222, 224).

The result after executing the loop of block 222 is a black-and-white image that describes the desired overall shape of the popup, taking into account all HTML pages that comprise it. The exemplary illustrative non-limiting example method then calls appropriate Microsoft OS API calls to build a window Region based on this image, apply it to the popup window, and display the popup on the screen (blocks 226, 228, 230). Such calls can use for example a conventional CreatePolygonRgn CombineRgn and other GDI (GDI+) API calls. See for example Lehman, Dale E. “Creating High-Tech Forms in Visual Basic, Parts I-III, Visual Basic Web Magazine, and Windows Development Kit documentation published by Microsoft Corp. on GDI and GDI+ such as “GDI+” documentation available from the MSDN Library, all incorporated herein by reference.

### Discussion of Example Illustrative Non-Limiting Alternative Implementations

What's the best way to describe a shape? In general, it does not matter where the overlay bitmask comes from—it can be somehow generated on the fly, downloaded from the server (e.g. as a monochrome GIF file), described as a set of geometric shapes defined by their coordinates (similar to <map> and <area> tags in HTML), and so on. As described above, it can also be composed from several pieces, each of which is defined in one of the ways above. One exemplary illustrative non-limiting implementation allows advertisers to generate at least the source for the bit mask using conventional image authoring tools that output a black and white image in conventional image file formats.

Geometric description may in certain instances be difficult to author, most likely requiring specialized authoring tools. If geometric descriptions are supported, then one needs to decide how advanced a language for describing shapes to use. For example, it would be possible to define the geometry using just a set of rectangles, or by using things like ellipses, chords, pies, and Bezier curves. The ability to intersect two shapes, form a union of two shapes, exclude one from the other might also be useful.

It is probably more natural for Web and graphics designers to create BW images than mathematical descriptions. In fact, tools are readily available to cut a shape, say, off of a photograph and convert it to black-and-white silhouette (Adobe Photoshop® can do that and more). Another way is defining a shape by providing a monochrome image. For example, when creating EyeBlaster-style ads, where the popup is a truly creative shape (such as the crystal ball example above), such a popup can simply be accompanied by one monochrome image, as large as the popup itself. Where shaper technology is being used for mildly enhancing a basic rectangular shape, e.g. making popups with rounded or shaved-off corners, it may be impractical in some contexts to create an image for each popup since they come in widely different sizes. In fact, if we want a shape to accompany a skin, we should define it in such a way that it easily adapts to a popup of any size, just as the skin itself does. This means we would like to separately define the shape of popup corners, which would allow popups looking like rectangles with rounded corners. Possibly the shape elements that will be repeated along the sides of the popup, which would allow shapes like, for example, a coupon with cut-off line and scissors. Both uses have their place and should preferably be supported. But actually, the first is a special case of the second—it can be described as a huge mask for top-left corner, with no masks for other corners and sides. A possible disadvantage of monochrome image approach vs. geometric approach is its asynchronous nature. Once the shape is specified, one would then download all the necessary pieces as a separate step, which may take a noticeable amount of time or even fail altogether.

Still another approach uses a single image approach. A one-image approach has potential advantages from a performance point of view. Each image requires a separate HTTP request. Those images are generally going to be tiny, with sizes ranging from a couple dozen to a couple hundred bytes. The transmission time of such small images is on the par with the overhead of establishing an HTTP connection. For example, retrieving 8 small images generates about 8 times the traffic of retrieving one larger image (but even this traffic is still light—there may be hundreds of bytes involved). In addition, the more requests made, the higher the possibility that one of them fails (times out or something). With the one image approach, somebody may need to pack all pieces together on one image, e.g. in a slide strip fashion or maybe in an actual shape of a small popup, then figure out coordinates to go with the image. Besides, since the coordinates and the image may travel through the workflow process separately, there is a possibility of them getting out of sync, e.g. due to a human error (somebody misses a digit when copying, or an artist edits the image and forgets to update corresponding coordinates).

What it the best way to apply shaping to a popup? There are at least two approaches—specifying the shape in the database, and specifying the shape in the HTML creative. The first approach follows an established pattern. A shape table is created in the client database that describes what I need to know to apply particular shape (e.g. an image URL and 8 rectangular coordinates, or 8 image URLs). A shape is identified by some kind of shape ID. This shape ID is then mentioned in the “popup features” (an internal description that makes use of a client database table for referencing specific client database structures). This is useful because a shape is likely to accompany branding and/or skins which are also specified in such client database. In one exemplary illustrative non-limiting implementation, the client 126 gets a shape ID from the “popup features” client database structure(s), looks the shape up in the database and applies the shape. This is a potentially useful approach. One potential drawback however is that you have two related pieces of information traveling through the workflow that must be kept consistent with each other. One team may be responsible for designing a shape, a different team is then responsible for configuring it properly.

Another approach is to specify the shape right in the HTML creative as described above. Note that in practice, a shape may be very tightly coupled with the underlying creative. You cannot just slap a shape on an arbitrary HTML—it will not look right. An HTML should be carefully designed with the shape in mind. When specifying a shape in the creative, whoever authors the HTML also has control over the shape that will be applied to this creative. If the author modifies the creative, he or she can easily keep the shape in sync with the changes.. But of course there are issues with this approach, too. One issue is how to deal with popups that have frames, each with its own creative and possibly specifying a shape. In the presence of skins, pretty much every popup has at least five frames. Semantics should be developed for having each frame specify a shape. It would be possible for a shape specified on a frame to be applied only to this frame, thus having each frame with its own shape. But perhaps shapes specified on different frames ought to be merged or composed somehow. The client 126 may simply treat multiple shapes as an error, and fail to apply any shape or even close the popup without ever showing it. As a practical consideration: a skin generally consists of four separate HTML files. It is possible to have each skin piece specify only the elements of the shape that pertain to it (say, top piece specifies two top corners and bottom piece specifies two bottom corners). However, it may be easier to just choose one piece and specify the complete shape on it. One may wish to mix and match skin pieces to form different designs from existing parts.

Another potential issue has to do with performance again. When the skin is specified in the client software's local database 128, the necessary URLs are known up front, so it is possible to start downloading the pieces immediately, concurrently with the popup creative itself. When the skin is specified in the creative, it may be necessary to wait until the creative is fully loaded, read the skin specs from it, then proceed to download the skin elements. A popup can only be shown once the skin images have arrived. Thus, there is an extra delay between the time the creative is ready and the time the popup can be shown. However, as in the previous performance argument, the point becomes moot if we just use the same shape elements on every popup, as they are likely to sit in the browser cache. Besides, if this becomes a problem, HTML creative can employ standard techniques for preloading images into the cache.

Now, consider dynamic shaping, that is, the ability of the popup to change its shape after it is shown, possibly driven by script running on the creative. Note—Window regions technology is generally too slow to support anything close to real-time animation, but it is possible to provide a popup that changes its shape occasionally—e.g., a coupon popup may change the shape of its corners and edges when flipping from a front page to a back page, or when collapsing and expanding (we have a “clipTo” feature and associated API client call for that, but it currently only allows applying or removing an additional rectangular mask).

Dynamic shaping poses its own unique challenges. For example, if we go with creative-driven shape specification, we could reapply the shape whenever there is a navigation within the popup. If the second page does not specify any shape, this could mean that it wants all shaping removed or it could mean that it is happy with whatever shape is established by the previous page. If only one frame is navigated, it may be desirable to treat a shape specified on the back page of this frame. For example, it may be possible to merge it with the current shape, or replace the current shape with new one, or simply ignore the new shape.

If a shape is to be applied via a script method call, we would like some compact and convenient way to specify a shape. Eight URLs may be a bit unwieldy (though possible) to specify, which may tip the scales in favor of one image approach to specifying shapes, or maybe even geometric approach. If dynamic shaping is supported and is scriptable, one may need to decide whether the script can use geometric or image shape specification, or both. If the script is allowed to use image specification, then should the asynchronous nature of the approach should be considered.

Suppose the script has somehow communicated the shape specification. Now I have to actually go and download new shape pieces, which potentially can take a noticeable amount of time. Thus the process of applying a shape becomes asynchronous, which could make it hard for the script to coordinate HTML changes and shaping. You would be able to see new content with old shape applied. This problem can make geometric approach attractive, at least in this niche. In fact, clipTo is a working example of just such an approach. Then again, if we implement geometric specification here, we may just as well implement it everywhere, in addition to or instead of a monochrome image approach. This problem can be mitigated by the script employing image preloading techniques. Still, it may be difficult to make shape transition absolutely smooth with image-specified shapes.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

1. A method of remotely delivering advertising to a display device comprising:
(a) delivering advertising material on demand via at least one network;
(b) separately delivering at least one overlay via said at least one network; and
(c) applying said overlay to said delivered advertising material to define the shape said advertising material is displayed within.

2. The method of claim 1 wherein said advertising material comprises a rectangular image, and said overlay defines portions of said rectangular image as transparent.

3. The method of claim 1 wherein said overlay comprises a monochrome image.

4. The method of claim 1 wherein said overlay comprises a geometric description.

5. The method of claim 1 wherein said applying step includes generating at least one Regions API call to the Microsoft Windows operating system.

6. The method of claim 1 wherein said advertising material comprises rich media.

7. The method of claim 1 wherein said overlay comprises a plurality of different image files corresponding to different portions of said advertising material.

8. The method of claim 7 wherein said plurality of different image files correspond to different portions of a rectangle including corners and sides.

9. The method of claim 1 wherein said advertising material comprises at least one web page.

10. The method of claim 1 wherein said applying step includes displaying said shaped advertising material on a background.

11. The method of claim 1 wherein said overlay defines portions of said advertising material that are transparent to mouse clicks.

12. The method of claim 1 wherein said applying step displays said shaped advertising material outside of any web browser view.

13. A system for remotely delivering advertising to a display device comprising:
means for delivering advertising material on demand via at least one network;
means for separately delivering at least one overlay via said at least one network; and
means for applying said overlay to said delivered advertising material to define the shape said advertising material is displayed within.

14. A system for displaying advertising delivered from a remote location, comprising:
means for receiving advertising material on demand via at least one network;
means for separately receiving at least one overlay via said at least one network; and
means for applying said overlay to said delivered advertising material to define the shape said advertising material is displayed within.

15. A method of displaying information comprising:
(a) selecting information for display at least in part in response to real time interaction with a consumer using a networked computing appliance;
(b) retrieving said selected information over a network;
(c) applying an associated non-rectangular shape to said retrieved information; and
(d) displaying said retrieved information within said shape on a background display.

16. The method of claim 15 wherein said applying comprises applying an overlay to define transparent and non-transparent portions of said retrieved selected information.

17. The method of claim 15 wherein said retrieved selected information comprises a rectangular graphical image.

18. The method of claim 15 wherein said retrieved selected information comprises an advertisement.

19. The method of claim 15 wherein said selecting comprises analyzing consumer browsing and targeting an advertisement at least in part in response thereto.

20. The method of claim 15 wherein said displaying comprises displaying said shape behind and outside of any open browser windows.

21. The method of claim 15 further including allowing consumer-initiated mouse clicks to penetrate portions of said display defined as transparent.

22. A storage medium comprising:
a first storage area storing a creative retrieved over a network from a remote advertising server;
a second storage area storing at least one overlay for application to said creative; and
program code that causes said creative to be displayed in a shape defined by said overlay, outside of any browser window.

23. A method of displaying information comprising:
(a) selecting information for display at least in part in response to user input;
(b) retrieving said selected information over the Internet;
(c) also retrieving, over the Internet, information defining a non-rectangular shape for displaying said selected information; and
(d) displaying said retrieved information within said non-rectangular shape outside of a browser view

24. The method of claim 23 wherein said displaying comprises displaying said information within a non-contiguous non-rectangular shape.

25. The method of claim 23 wherein said displaying includes displaying animated information within said non-rectangular shape.

26. The method of claim 23 wherein said displaying includes displaying said retrieved information within a pop-up having portions that are transparent to mouse clicks.

27. The method of claim 23 wherein said displaying includes displaying said retrieved information as part of a desktop.

28. The method of claim 23 wherein said displaying includes displaying said retrieved information in front of an application other than a browser view.
